(19) United States
(12) Patent Application Publication
(10) Pub. No.: US 2024/0304180 A1
(43) Pub. Date: Sep. 12, 2024

(54) ITERATIVE IMPROVEMENT OF SPEECH RECOGINITION, VOICE CONVERSION, AND TEXT-TO-SPEECH MODELS

(71) Applicant: SONY GROUP CORPORATION, TOKYO (JP)

(72) Inventors: MAYANK KUMAR SINGH, BANGALURU (IN); NAOYA TAKAHASHI, TOKYO (JP); NAOYUKI ONOE, TOKYO (JP)

(21) Appl. No.: 18/596,715

(22) Filed: Mar. 6, 2024

Related U.S. Application Data
(60) Provisional application No. 63/488,828, filed on Mar. 7, 2023.

(51) Int. Cl. G10L 15/06; G10L 13/04; G10L 15/01; G10L 25/18

(52) U.S. Cl. CPC G10L 15/063; G10L 13/04; G10L 15/01; G10L 25/18

(57) ABSTRACT

An electronic device and method for iterative enhancement of speech recognition, voice conversion, and text-to-speech models are disclosed. The electronic device receives a text dataset and a dataset associated with a speech recognition task. Speech recognition, voice conversion, and TTS conversion models are trained for corresponding tasks. The device further iteratively executes operations, which include: generating an augmented speech dataset via application of the trained voice conversion model, finetuning the TTS conversion model using the augmented speech dataset, applying the finetuned TTS conversion model to the text dataset to generate speech samples, applying the trained voice conversion model to the speech samples to create an augmented text-speech dataset, finetuning the speech recognition model utilizing the augmented text-speech dataset, and finetuning the trained voice conversion model using the finetuned speech recognition model. This operations are executed until a loss associated with the voice conversion model falls below a threshold loss.

### CROSS-REFERENCE TO RELATED APPLICATIONS/INCORPORATION BY REFERENCE

This application claims priority to U.S. Provisional Patent Application Ser. No. 63/488,828 filed on Mar. 7, 2023, the entire content of which is hereby incorporated herein by reference.

### FIELD

Various embodiments of the disclosure relate to speech processing and machine learning. More specifically, various embodiments of the disclosure relate to iterative improvement of speech recognition, voice conversion, and text-to-speech models.

### BACKGROUND

Advancements in speech processing have led to the development of various models for voice conversion and automatic speech recognition. However, training these models on low-resource domains presents challenges, as they may become overfitted and unsuitable for practical applications. Furthermore, the voice conversion model may rely on the automatic speech recognition model to extract features from audio content. If the accuracy of the automatic speech recognition model is sub-optimal, the extracted features may also be sub-optimal, negatively impacting the training of the voice conversion model.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for iterative improvement of speech recognition, voice conversion, and text-to-speech models as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for iterative improvement of speech recognition, voice conversion, and text-to-speech models, in accordance with an embodiment of the disclosure.

FIG. 2 is a block diagram that illustrates an exemplary electronic device of FIG. 1, in accordance with an embodiment of the disclosure.

FIG. 3 is a flowchart that illustrates exemplary operations for iterative training of text-to-speech model, in accordance with an embodiment of the disclosure.

FIGS. 4A and 4B illustrate a flowchart comprising exemplary operations for iterative improvement of speech recognition, voice conversion, and text-to-speech models, in accordance with an embodiment of the disclosure.

FIG. 5 is a diagram that illustrate an exemplary processing scenario for training of a voice conversion model, in accordance with an embodiment of the disclosure.

FIG. 6 is a diagram that illustrates an exemplary scenario for an iterative training of a speech recognition model and a voice conversion model, in accordance with an embodiment of the disclosure.

### DETAILED DESCRIPTION

The following described implementation may be found in an electronic device and method for iterative improvement of speech recognition, voice conversion, and text-to-speech models. Exemplary aspects of the disclosure provide an electronic device that performs various speech processing tasks using machine learning models. The electronic device includes circuitry that may receive a dataset associated with a speech recognition task, as well as a text dataset. The device may train three separate models using this data: a speech recognition model for a speech recognition task, a voice conversion model for converting the spoken words of one person into those of another, and a text-to-speech (TTS) conversion model for converting written text into spoken words.

Once these models have been trained, the device may apply them to different tasks. First, the device may generate an augmented speech dataset by applying the voice conversion model to the original dataset. The augmented speech dataset may be used to finetune the TTS conversion model, which may convert written text into speech based on the pronunciations of a specific individual (or “voice”). The finetuned TTS conversion model may then be applied to the text dataset to generate speech samples corresponding to each text sample. Thereafter, the device may apply the voice conversion model again, this time to the generated speech samples. This results in an augmented text-speech dataset, which can be used to further refine the speech recognition and voice conversion models. Specifically, the device may finetune these models using this new dataset until a specific loss threshold is reached for the voice conversion model.

The disclosure describes a process of training multiple machine learning models for different tasks (speech recognition, voice conversion, and text-to-speech), generating an augmented speech dataset to improve TTS conversion model accuracy, applying the voice conversion model again to this augmented data to improve speech recognition and voice conversion model accuracy, and repeating these steps until a specific loss threshold is reached for the voice conversion model. The fine tuning of these three models may be performed in a staggered manner, in which weight parameters of other models may be frozen while weight parameters of a model are updated.

The task of training the voice conversion model, the automatic speech recognition model, and/or the text-to-speech (TTS) conversion model on low resource domains is challenging as models trained on low resource domain datasets may overfit and may not be useful for practical applications. A low-resource domain in terms of training refers to a specific area or field where there is limited availability of labeled data for training machine learning models. This scarcity of data can make it challenging to develop effective models that can generalize well to other domains with limited training examples. As voice conversion models often rely on ASR model for extracting content features or imposing content consistency loss, degradation of ASR directly affects the quality of VC models.

In order to address the aforesaid issues, the disclosure provides a training framework used for iterative improvement of a speech recognition model by using the voice conversion model as a data augmentation method for training the speech recognition model and simultaneously improve the voice conversion model by using the ASR model for linguistic content preservation. Additionally, the training framework for training of the voice conversion model uses an encoder of the speech recognition model as an auxiliary loss to preserve the linguistic content. For training the voice conversion model, the trained or finetuned speech recognition model may help to extract better linguistic features and generate speaker independent encoder features that may lead to better content preservation and clarity. Similarly, for training the speech recognition model, the trained or finetuned voice conversion model may help to preserve more linguistic content and produce less artefacts (and leads to generation of more realistic samples for data augmentation).

By generating an augmented speech dataset using the voice conversion model, the TTS conversion model may be finetuned with more data specific to a particular speaker's pronunciations. This may result in improved accuracy for text-to-speech conversions, as the generated speech samples will better match the original spoken words. The training framework also involves finetuning both the speech recognition and voice conversion models using an augmented text-speech dataset. This may improve the robustness of these models by exposing them to a wider range of speech patterns and variations, making them better able to accurately recognize and convert speech in real-world conditions. By generating an augmented speech dataset using voice conversion, the framework may reduce the need for large amounts of labeled data specific to each individual's pronunciations. This may significantly reduce computational requirements for training the TTS conversion model and improve efficiency in the overall system.

The training framework has a potential to significantly improve the accuracy, robustness, computational requirements, and memory usage of speech processing systems using machine learning models for speech recognition, voice conversion, and text-to-speech tasks. By iteratively training the speech recognition, voice conversion, and text-to-speech models, the improved models may be leveraged for training the next iteration and thus achieve better performance on different objective and subjective metrics.

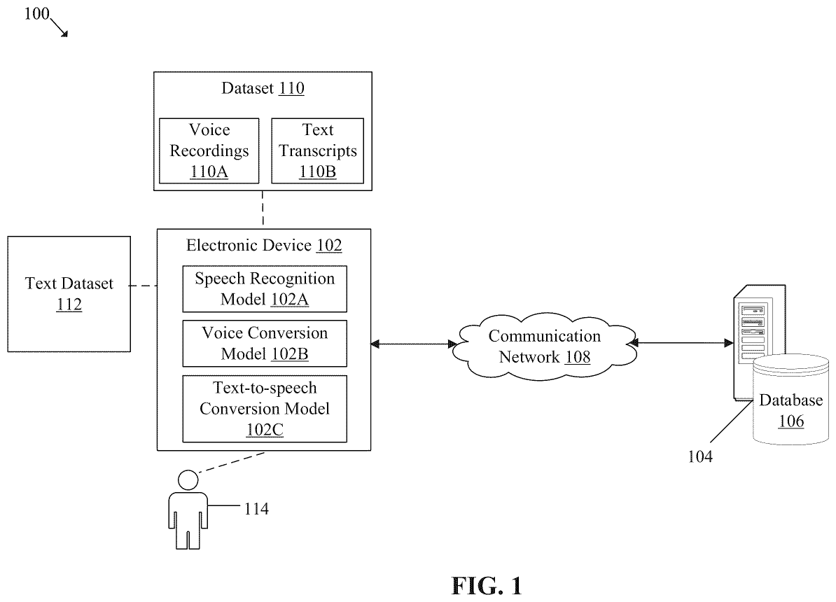

FIG. 1 is a block diagram that illustrates an exemplary network environment for iterative improvement of speech recognition, voice conversion, and text-to-speech models, in accordance with an embodiment of the disclosure. With reference to FIG. 1, there is shown a network environment 100. The network environment 100 may include an electronic device 102, a server 104, a database 106, and a communication network 108. The electronic device 102 may be configured to store model files for a speech recognition model 102A, a voice conversion model 102B, and/or a text-to-speech (TTS) conversion model 102C. The electronic device 102 may also store a dataset 110 and a text dataset 112. The dataset 110 may include voice recordings 110A and text transcripts 110B, for example. The electronic device 102 may communicate with the server 104 through one or more networks (such as the communication network 108). There is further shown a user 114 who may be associated with the electronic device 102.

The electronic device 102 may include suitable logic, circuitry, interfaces, and/or code that may be configured to train multiple machine learning models for different tasks (speech recognition, voice conversion, and text-to-speech), generating an augmented speech dataset to improve TTS conversion model accuracy, applying the voice conversion model 102B again to the augmented speech data to improve speech recognition and voice conversion model accuracy, and repeating the training operations until a specific loss threshold is reached for the voice conversion model 102B. Examples of the electronic device 102 may include, but are not limited to, a computing device, a smartphone, a cellular phone, a mobile phone, a gaming device, a mainframe machine, a server, a computer workstation, a machine learning device (enabled with or hosting a computing resource, a memory resource, and a networking resource, for example), and/or a consumer electronic (CE) device.

The speech recognition model 102A is a speech-to-text model that may be trained for a speech recognition task (i.e., to predict spoken words in speech inputs provided in a dataset). Specifically, the speech recognition model 102A may be defined as a computational system designed to process and convert spoken language (an audio signal) into written text. In an exemplary embodiment, the speech recognition model 102A may be based on ESPNet framework having a hybrid CTC-Attention model. The speech recognition model 102A may be also implemented using traditional statistical algorithms like Hidden Markov models (HMM) and dynamic time warping (DTW), or deep learning techniques such as neural networks. Specific examples of the speech recognition model 102A may include, but are not limited to, Quartznet, Citrinet, and Conformer. In accordance with an embodiment, a deep learning pipeline for speech recognition may include data preprocessing, a neural acoustic model, a decoder (optionally coupled with an n-gram language model), and a punctuation and capitalization model.

The speech recognition model 102A may be defined by its hyper-parameters, for example, number of weights, cost function, input size, number of layers, and the like. During training, the parameters of the speech recognition model 102A may be updated so as to move towards a global minima of a cost function for the speech recognition model 102A. After several epochs of the training on feature information in the training dataset, the speech recognition model 102A may be trained to output a prediction result (e.g., a spoken text) for an unseen speech input.

The speech recognition model 102A may include electronic data, which may be implemented as, for example, a software component of an application executable on the electronic device 102. The speech recognition model 102A may rely on libraries, external scripts, or other logic/instructions for execution by a processing device. The speech recognition model 102A may include code and routines configured to enable a computing device to perform one or more operations such as determination of the set of session slots. Additionally, or alternatively, the speech recognition model 102A may be implemented using hardware including a processor, a microprocessor (e.g., to perform or control performance of one or more operations), a field-programmable gate array (FPGA), or an application-specific integrated circuit (ASIC). Alternatively, in some embodiments, the speech recognition model 102A may be implemented using a combination of hardware and software.

The voice conversion model 102B may be a model used for execution of a voice conversion task. The voice conversion model 102B may be referred to as a computational system that converts one speaker's voice into another's voice while preserving linguistic and prosodic information such as phonemes and prosody. The voice conversion model 102B aims to modify the speech of a source speaker and make the speech sound like that of another target speaker without changing the linguistic information. The voice conversion model 102B may use deep learning and generative models to achieve the desired voice conversion. In an exemplary embodiment, the voice conversion model 102B may be based on a Generative Adversarial Network (GAN) network. Specific examples of the voice conversion model 102B may include, but are not limited to, SoftVC, StyleTTS-VC, YourTTS, and non-autoregressive sequence-to-sequence (NAR-S2S) models.

The TTS conversion model 102C may be a prediction model used for execution of a text-to-speech conversion task. Specifically, the TTS conversion model 102C may be a computational system that converts textual inputs into natural human speech. The model may use machine learning algorithms to synthesize the text provided into an AI-generated voice that reads the text aloud. The TTS conversion model 102C may generate speech in multiple languages and for multiple speakers. Examples of the TTS conversion model 102C may include, but are not limited to, TensorFlow® TTS, FastSpeech, Voicebox, Speechify, and other models, such as Bark, MMS, VITS, and SpeechT5.

In an embodiment, each of the speech recognition model 102A, the voice conversion model 102B, and the TTS conversion model 102C may be a neural network (NN). The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In training of the neural network, one or more parameters of each node of the neural network may be updated based on whether an output of the final layer for a given input (from the training dataset) matches a correct result based on a loss function for the neural network. The above process may be repeated for the same or a different input until a minima of loss function is achieved, and a training error is minimized. Several methods for training are known in art, for example, gradient descent, stochastic gradient descent, batch gradient descent, gradient boost, meta-heuristics, and the like.

The neural network may include electronic data, which may be implemented as, for example, a software component of an application executable on the electronic device 102. The neural network may rely on libraries, external scripts, or other logic/instructions for execution by a processing device. The neural network may include code and routines configured to enable a computing device to perform one or more operations for determination of the set of session slots. Additionally, or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

The server 104 may include suitable logic, circuitry, and interfaces, and/or code that may be configured to store training data and model files related to trained or untrained models such as the speech recognition model 102A, the voice conversion model 102B, or the TTS conversion model 102C. In at least one embodiment, the server 104 may be used to deploy the speech recognition model 102A, the voice conversion model 102B, or the TTS conversion model 102C for inference. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure is not limited to the implementation of the server 104 and the electronic device 102 as two separate entities. In certain embodiments, the functionalities of the server 104 can be incorporated in its entirety or at least partially in the electronic device 102, without a departure from the scope of the disclosure. In certain embodiments, the server 104 may host the database 106. Alternatively, the server 104 may be separate from the database 106 and may be communicatively coupled to another system that may host the database 106.

The database 106 may include suitable logic, interfaces, and/or code that may be configured to store training data that includes the dataset 110, the text dataset 112, and/or an augmented speech dataset. The database 106 may be derived from data off a relational or non-relational database, or a set of comma-separated values (csv) files in conventional or big-data storage. The database 106 may be stored or cached on a device, such as, a server (e.g., the server 104) or the electronic device 102. For example, the device storing the database 106 may be configured to receive a query for the dataset 110 from the electronic device 102. In response, the device storing the database 106 may be configured to retrieve and provide the dataset 110 to the electronic device 102.

In some embodiments, the database 106 may be hosted on a plurality of servers at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102 and/or the server 104 may communicate with one another. The communication network 108 may be one of a wired connection or a wireless connection. Examples of the communication network 108 may include, but are not limited to, the Internet, a cloud network, Cellular or Wireless Mobile Network (such as Long-Term Evolution and 5th Generation (5G) New Radio (NR)), satellite communication system (using, for example, a network of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

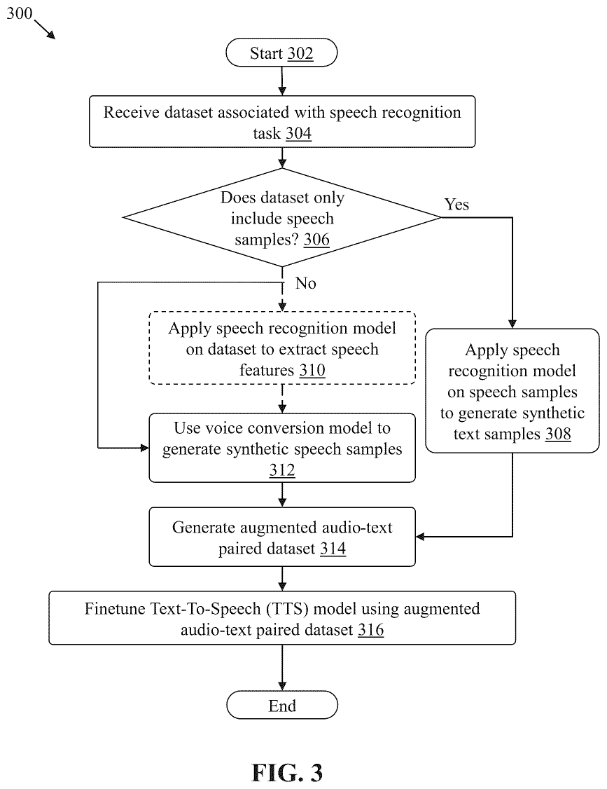

In operation, the electronic device 102 may be configured to receive the dataset 110 associated with a speech recognition task. The dataset 110 may include the voice recordings 110A of a set of human speakers in one or more languages and the text transcripts 110B corresponding to the voice recordings 110A. By way of example, and not limitation, the dataset 110 may be stored in a database, such as the database 106. Details related to the reception of the dataset 110 are further provided, for example, in FIG. 3 (at 302).

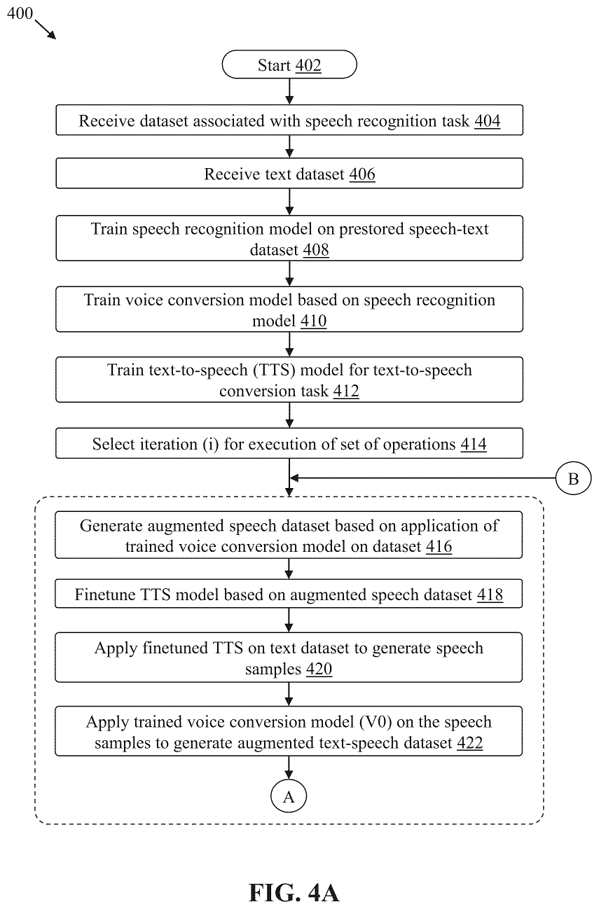

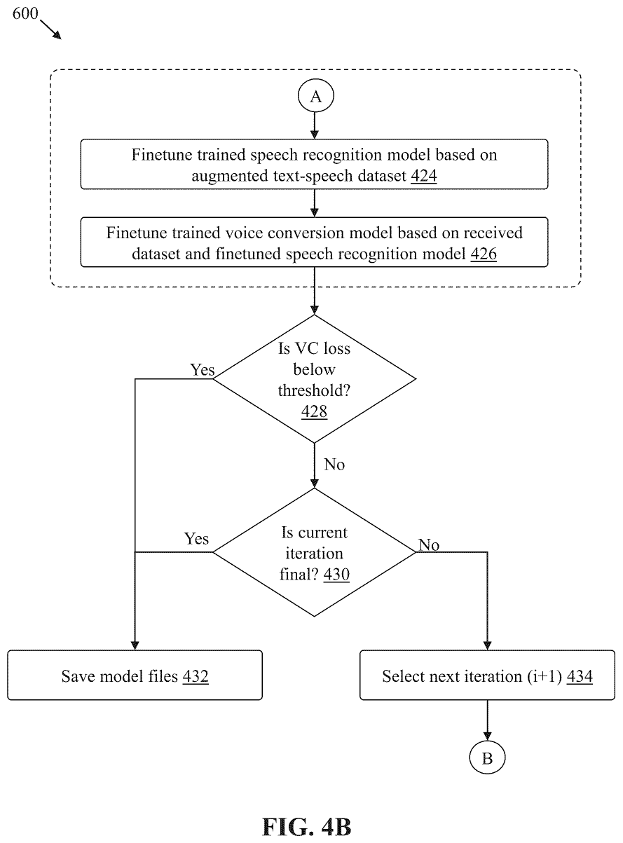

After the reception, the electronic device 102 may train the speech recognition model 102A for the speech recognition task. The training of the speech recognition model 102A may be performed based on a standard audio-text paired dataset. Similarly, the electronic device 102 may train the voice conversion model 102B for a voice conversion task and the TTS conversion model 102C for a text-to-speech conversion task. The training of the voice conversion model 102B may be performed based on the trained speech recognition model 102A. Details of the training of the voice conversion model 102B are provided in FIGS. 4A and 4B, for example.

After an initial training, the electronic device 102 may execute, as part of a finetuning loop, a set of operations for a number of iterations until a voice conversion loss associated with the voice conversion model 102B is below a threshold loss. Additionally, or alternatively, the set of operations may be executed until a Word Error Rate (WER) associated with the speech recognition model 102A is below a threshold WER loss. Additionally, or alternatively, the set of operations may be executed until the number of the iterations until a TTS loss associated with the TTS conversion model 102C is below a threshold TTS loss.

As part of the operations, the electronic device 102 may execute an operation to generate an augmented speech dataset based on an application of the trained voice conversion model on the dataset 110. For data augmentation, both source and reference voice data may be sampled from the dataset 110 and provided to the trained voice conversion model 102B to artificially increase the diversity of the training samples in terms of speaker style. Additionally, a set of speaker embeddings may be provided as inputs to the trained voice conversion model 102B, and the trained voice conversion model 102B may generate the augmented speech dataset based on the inputs. A speaker embedding typically represents a speaker's identity in a compact way as a vector of fixed size, regardless of the length of the utterance. The speaker embedding may encode speaker characteristics of an utterance into a fixed-length vector using neural networks and may be used to classify and discriminate between different speakers. In an embodiment, the voice recordings 110A may be excluded from the augmented speech dataset. The augmented speech dataset may include converted voice recordings. Details related to the generation of the augmented speech dataset are further provided, for example, in FIGS. 4A and 4B.

After speech augmentation, the electronic device 102 may execute an operation to finetune the TTS conversion model 102C based on the augmented speech dataset. In case the original dataset (i.e., the dataset 110) only includes speech samples, the trained speech recognition model 102A may be applied on the speech samples to generate synthetic text samples that may be paired with the speech samples. The paired speech-text samples may be used to finetune the TTS conversion model 102C.

The electronic device 102 may further execute the operation to apply the finetuned TTS conversion model 102C on the text dataset 112 to generate speech samples corresponding to the text samples in the text dataset 112. Thereafter, the electronic device 102 may apply the trained voice conversion model 102B on the speech samples (synthetically generated) to generate augmented text-speech dataset. In accordance with an embodiment, the trained speech recognition model 102A may be applied on the speech samples to extract speech features (e.g., neural network features or embeddings) that may be provided as an input to the trained voice conversion model 102B for the generation of the augmented text-speech paired dataset. The augmented text-speech dataset may be used to finetune the trained speech recognition model 102A and the finetuned speech recognition model 102A may be used to finetune the voice conversion model 102B. The set of operations may be executed for a number of iterations until a loss (e.g., speech consistency loss) associated with the finetuned voice conversion model 102B is below a threshold loss.

Due to data augmentation of the dataset 110, the augmented dataset may include a diverse variety of spoken audio samples from a variety of speakers. The diversity may help to improve accuracy of the finetuned speech recognition model 102A, the finetuned voice conversion model 102B, and the finetuned TTS conversion model 102C.

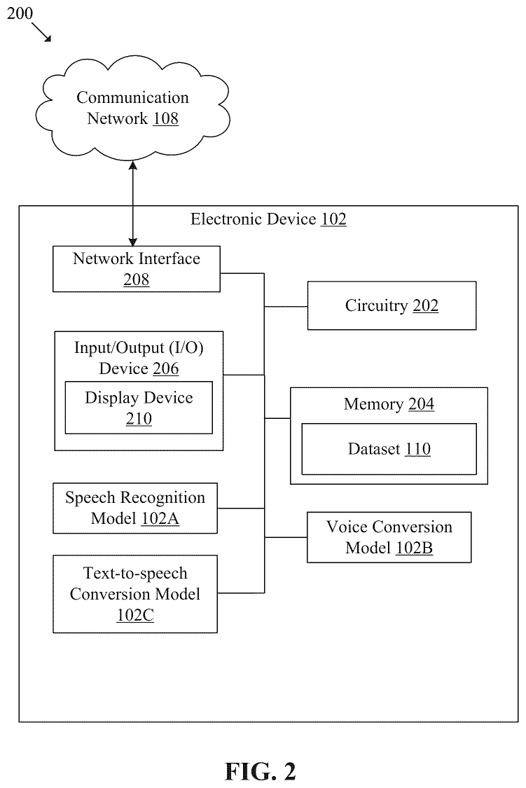

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, a network interface 208, the speech recognition model 102A, the voice conversion model 102B, and the TTS conversion model 102C. The memory 204 may include the dataset 110 and the text dataset 112. The input/output (I/O) device 206 may include a display device 210.

The circuitry 202 may include suitable logic, circuitry, and/or interfaces that may be configured to execute program instructions associated with different operations to be executed by the electronic device 102. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be further configured to store the dataset 110. Example implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include the display device 210. Examples of the I/O device 206 may include, but are not limited to, a display (e.g., a touch screen), a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102 and/or the server 104, and/or the server 104, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display or render the text transcripts 110B. The display device 210 may be a touch screen which may enable a user (e.g., the user 114) to provide a user-input via the display device 210. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for iterative improvement of speech recognition, voice conversion, and text-to-speech models are described further, for example, in FIG. 3.

FIG. 3 is a flowchart that illustrates operations of an exemplary method for training of a text-to-speech model, in accordance with an embodiment of the disclosure. FIG. 3 is described in conjunction with elements from FIG. 1 and FIG. 2. With reference to FIG. 3, there is shown a flowchart 300. The flowchart 300 may include operations from 302 to 316 and may be implemented by the electronic device 102 of FIG. 1 or by the circuitry 202 of FIG. 2. The flowchart 300 may start at 302 and proceed to 304.

At 304, a dataset (e.g., dataset 110) associated with a speech recognition task may be received. In an embodiment, the circuitry 202 may receive the dataset. The dataset may be a speech only dataset or may at least include voice recordings and a textual transcript of each voice recording. For example, the received dataset 110 may include the voice recordings 110A of a set of human speakers in one or more languages and the text transcripts 110B corresponding to the voice recordings 110A. The set of human speakers may be of different age groups. As an example, a voice recorder may record a voice of the user 114 in English. The voice recording of the user 114 and the text transcripts 110B of voice recordings may be stored in the database 106.

At 306, it may be determined whether the dataset only includes the speech samples in the dataset. In case the dataset only includes the speech samples in the dataset, control may pass to 308. In case the dataset includes the speech samples and corresponding text samples in the dataset, control may pass to 310.

At 308, the speech recognition model 102A may be applied on the speech samples of the dataset to generate synthetic text samples corresponding to the speech samples. The speech recognition model 102A may be a deep neural network that may be pretrained on a standard audio-text dataset. In an embodiment, the circuitry 202 may apply the speech recognition model 102A on the speech samples of the dataset. Each synthetic text sample may include a text transcript (spoken text) of a corresponding speech sample.

At 310, the speech recognition model 102A may be applied on the dataset to extract speech features associated with the speech samples of the dataset. In at least one embodiment, the feature extraction may yield a multidimensional feature vector for every speech sample. Some of the features typically extracted include Mel-Frequency Cepstral Coefficients (MFCC) and Perceptual Linear Prediction (PLP).

At 312, an input may be fed to the voice conversion model 102B. In an embodiment, the input may include the speech samples of the dataset. Additionally, the input may include the extracted features. The voice conversion model 102B may generate synthetic speech samples based on the inputs. The voice conversion model 102B may be trained using a standard method for a first iteration and for further iterations, a refined (or finetuned) voice conversion model may be used. For each speech sample as input, multiple synthetic speech samples may be generated in different voices.

At 314, an augmented audio-text paired dataset may be generated based on the synthetic speech samples. The augmented audio-text paired dataset may include the speech samples of the dataset and the synthetic speech samples (generated at 312). Additionally, the augmented audio-text paired dataset may also include the synthetic text samples (in case the dataset includes only speech samples) or text samples originally present in the dataset.

At 316, the TTS conversion model 102C may be trained (from scratch) or finetuned based on the augmented audio-text paired dataset. The fine-tuning of the TTS conversion model 102C may involve taking a pre-trained TTS conversion model and retraining the TTS conversion model 102C to improve its performance on a different task or dataset (such as the augmented audio-text paired dataset). In a direct fine-tuning approach, all parameters of the pre-trained TTS conversion model may be finetuned directly on the augmented audio-text paired dataset. In accordance with an embodiment, the TTS conversion model 102C may be finetuned to minimize a speech recognition loss.

It should be noted that the operations from 304 to 316 are described for a single iteration. The operations from 304 to 316 may be repeated for a number of iterations until the loss (e.g., speech recognition loss) is below a threshold loss.

Although the flowchart 300 is illustrated as discrete operations, such as 304, 306, 308, 310, 314, and 316, the disclosure is not so limited. Accordingly, in certain embodiments, such discrete operations may be further divided into additional operations, combined into fewer operations, or eliminated, depending on the implementation without detracting from the essence of the disclosed embodiments.

FIGS. 4A and 4B illustrate a flowchart comprising operations for iterative improvement of speech recognition, voice conversion, and text-to-speech models, in accordance with an embodiment of the disclosure. FIGS. 4A and 4B are described in conjunction with elements from FIG. 1, FIG. 2, and FIG. 3. With reference to FIGS. 4A and 4B, there is shown a flowchart 400. The flowchart 400 may include operations from 402 to 434 and may be implemented by the electronic device 102 of FIG. 1 or by the circuitry 202 of FIG. 2. The flowchart 400 may start at 402 and proceed to 404.

At 404, a dataset (e.g., dataset 110) associated with a speech recognition task may be received. The dataset may be a speech only dataset or may be an audio-text paired dataset that includes voice recordings and a textual transcript for each voice recording.

At 406, a text dataset (e.g., text dataset 112) may be received. The text dataset may include text samples, each of which may include a transcript or a spoken text of a speech.

At 408, the speech recognition model 102A may be trained for the speech recognition task. The training of the speech recognition model 102A may be performed based on a standard audio-text paired dataset. In an embodiment, the circuitry 202 may be configured to freeze training parameters of the voice conversion model 102B and/or the TTS conversion model 102C while the speech recognition model 102A is trained (or finetuned). As an example, weights associated with the voice conversion model 102B may be frozen during training of the speech recognition model 102A.

At 410, the voice conversion model 102B may be trained for a voice conversion task based on the trained speech recognition model. In an embodiment, the circuitry 202 may be configured to generate mel-spectrograms corresponding to the voice recordings 110A. A mel-spectrogram is a time-frequency representation of a voice recording. The voice recordings 110A may be provided as an input to a mel-spectrogram generator. The mel-spectrogram generator may generate the mel-spectrograms corresponding to the voice recordings 110A. The circuitry 202 may be configured to feed inputs that include the mel-spectrograms and speaker embeddings associated with the mel-spectrograms to the voice conversion model 102B to generate mel-spectrogram predictions. The speaker embedding may include information associated with a pitch, a loudness, an intensity of a voice of a human speaker. As an example, a first mel-spectrogram associated with a voice recording of a first user and a speaker embedding associated with a second user may be provided as an input to the voice conversion model 102B. The speaker embedding associated with a second user may indicate that the pitch of the second user is “10000” Hertz and the loudness of “6” Decibels. The voice conversion model 102B may generate a predicted mel-spectrogram. The predicted mel-spectrogram may include linguistic content of the first mel-spectrogram in a voice of the second user.

The circuitry 202 may be configured to compute a speech consistency loss by use of the trained speech recognition model 102A. The speech consistency loss may be computed based on the mel-spectrogram predictions and the inputs that include the mel-spectrograms. The voice conversion model 102B may be trained based on the computed speech consistency loss. As an example, the speech consistency loss may be determined using an equation (1):

$${ℒ}_{asr} ( θ ) - {𝔼𝔼}_{X , s} [ ‖ {h}_{asr} ( X ) - {h}_{asr} ( {V}_{θ} ( X , s ) ) ) ‖ ] \qquad ( 1 )$$

where,
“ [symbol] ₐₛᵣ” may be the speech consistency loss,
“X” may denote an input mel-spectrogram,
“hₐₛᵣ” may denotes encoder features of trained speech recognition model 102A,
“s” may be a speaker embedding of target human speaker,
“V” may be the voice conversion model 102B, and
“θ” may denote parameters of the voice conversion model 102B.
   The voice conversion model 102B may be conditioned upon the input mel-spectrogram “X” and the speaker embedding of “s”.

It should be noted that the output of an encoder of the trained speech recognition model 102A may be independent of a speaker identity and a pitch. That is, the trained speech recognition model 102A may only focus on linguistic content of the input mel-spectrogram “X”. The voice conversion model 102B may be trained such that the speech consistency loss is minimized. Minimization of the speech consistency loss may ensure that the voice conversion model 102B preserves the linguistic content during execution of the voice conversion task on an input mel-spectrogram.

In an embodiment, the circuitry 202 may be further configured to freeze training parameters of the speech recognition model 102A while the voice conversion model 102B is trained.

At 412, the TTS conversion model 102C may be trained for a text-to-speech conversion task. In an embodiment, the circuitry 202 may be configured to train the TTS conversion model 102C based on a standard audio-text paired dataset or an augmented audio-text paired dataset that may include synthetic text samples and/or synthetic speech samples (as described in FIG. 3).

At 414, an iteration (i) for execution of a set of operations may be selected. For example, iteration (i) may be selected as zero (0) at the beginning of a training loop for iterative finetuning of the speech recognition model 102A, the voice conversion model 102B, and the TTS conversion model 102C. After each loop of iteration (from 414 to 434), the value of iteration (i) may be updated (e.g., increase by 1). Operations from 416 to 434 are described herein for a single iteration of the training loop. The operations may be repeated for a number of iterations until a convergence condition is met (e.g., a minimization of a voice conversion loss or a speech recognition loss) or the value of the iteration (i) reaches a set maximum (e.g., ‘i’=100).

At 416, an operation may be executed to generate an augmented speech dataset based on application of the trained voice conversion model 102B (trained at 410) on the dataset. The voice recordings 110A may be provided as input along with features extracted using the trained speech recognition model 102A to the trained voice conversion model 102B. The trained voice conversion model 102B may generate synthetic voice recordings based on the input. By way of example, and not limitation, multiple synthetic voice recordings of speakers with different voices may be generated for each voice recording. The generated recordings may be used to augment the dataset (received at 402).

At 418, an operation may be executed to finetune the trained TTS conversion model 102C based on the augmented speech dataset. In an example embodiment, the circuitry 202 may be configured to finetune the trained TTS conversion model 102C until a speech consistency loss or a speech recognition loss is below a threshold loss. During the finetuning, the trained TTS conversion model 102C may learn to convert a given text sample in the augmented speech dataset to a speech sample. In an embodiment, the speech consistency loss may be determined based on a division of a number of erroneous words spoken in the converted speech sample by a total number if words present in a text sample associated with the converted speech sample. As an example, the threshold may be determined as “10” erroneous words for “1000” words in the text sample. That is, the threshold loss may be “0.01”. Further details related to the finetuning of the TTS conversion model 102C are provided in FIG. 3.

At 420, an operation may be executed to apply the finetuned TTS conversion model 102C on the text dataset 112 to generate speech samples corresponding to text samples in the text dataset 112. During inference, the circuitry 202 may apply the finetuned TTS conversion model 102C on the text dataset 112 to generate the speech samples. Each speech sample may be referred to as a synthetic speech or voice sample that may correspond to a text sample (or text transcript) of the text dataset 112.

In at least one embodiment, the trained speech recognition model 102A may be applied on the generated speech samples to extract speech features associated with the speech samples. Additionally, or alternatively, the voice recordings 110A included in the dataset 110 may be provided as an input to the trained speech recognition model 102A to extract speech features associated with the voice recordings 110A. In an embodiment, the feature extraction may yield a multidimensional feature vector for every speech sample or voice recording. Some of the features typically extracted include Mel-Frequency Cepstral Coefficients (MFCC) and Perceptual Linear Prediction (PLP).

At 422, an operation may be executed to apply the trained voice conversion model 102B on the generated speech samples to generate augmented text-speech dataset. Each speech sample (synthetic or recorded) in the augmented text-speech dataset may be provided as an input to the trained voice conversion model 102B along with a speaker embedding or an extracted speech feature. As an output, the trained voice conversion model 102B may output one or more converted speech samples in one or more speaker voices. Such converted speech samples may be used to further augment the augmented speech dataset, or the dataset (received at 402) if the dataset includes both speech samples and text samples.

At 424, an operation may be executed to finetune the trained speech recognition model 102A based on the augmented text-speech dataset. During finetuning, speech samples from a training set of the augmented text-speech dataset may be provided as input to the trained speech recognition model 102A and the training parameters of the trained speech recognition model 102A may be updated based on a loss (in terms of Word Error Rate (WER)) measured with respect to corresponding text samples in the training set. While the trained speech recognition model 102A is finetuned, the circuitry 202 may be configured to freeze training parameters (e.g., neural weights) of the trained voice conversion model 102B.

In an embodiment, the circuitry 202 may be configured to compute a loss in terms of the WER based on application of the trained speech recognition model 102A on a validation set of the augmented text-speech dataset. The circuitry 202 may be further configured to compare the determined WER with a threshold WER loss and the speech recognition model 102A may be finetuned based on the comparison. The validation set may include a subset of the voice recordings or the generated speech samples of the augmented text-speech dataset. The validation set may be provided as an input to the finetuned speech recognition model 102A and the finetuned speech recognition model 102A may generate text transcripts or text samples for the validation set. The generated text transcripts or text samples may be compared with a subset of the text samples included in the validation set. Thereafter, the loss in terms of the WER may be determined. The WER for the validation set may be determined by dividing a number of erroneous words by a total number of words in the generated text samples. In case the determined WER is less than the threshold WER loss, the speech recognition model 102A may be further finetuned. In case the determined WER is greater than the threshold WER loss, further training of the speech recognition model 102A may be stopped.

At 426, an operation may be executed to finetune the trained voice conversion model based on the received dataset (at 402) and the finetuned speech recognition model. In an embodiment, the generated mel-spectrograms corresponding to the voice recordings 110A of the dataset 110 and the speaker embeddings associated with the mel-spectrograms may be fed as an input to the trained voice conversion model 102B to generate mel-spectrogram predictions. Thereafter, the speech consistency loss may be determined by usage of the finetuned speech recognition model 102A and the trained voice conversion model 102B may be finetuned based on the computed speech consistency loss. Details related to the fine-tuning of the trained voice conversion model 102B is similar to the details related to the training of the voice conversion model 102B, as provided at 410.

The usage of the finetuned speech recognition model (for example, the speech recognition model 102A) for finetuning of the trained voice conversion model (for example, the trained voice conversion model 102B) may enable extraction of accurate linguistic features and generation of speaker independent encoder features. Thus, the finetuned voice conversion model (for example, the trained voice conversion model 102B) may preserve linguistic contents during execution of the voice conversion task.

In an embodiment, the circuitry 202 may be configured to freeze training parameters (e.g., neural weights) of the finetuned speech recognition model 102A while the voice conversion model 102B is finetuned.

At 428, it may be determined whether a voice conversion loss (e.g., the speech consistency loss) associated with the finetuned voice conversion model 102B is below a threshold loss. If the voice conversion loss (e.g., the speech consistency loss) associated with the finetuned voice conversion model 102B is below the threshold loss, control may pass to 432. Otherwise, the control may pass to 430.

At 430, it may be determined whether the selected iteration (i.e., current iteration, i) is the final iteration for the execution of the set of operations. In case the selected iteration is the final iteration, the control may pass to 432. Otherwise, the control may pass to 434.

At 432, model files and metadata associated with each of the speech recognition model 102A, the voice conversion model 102B, and the TTS conversion model 102C may be saved as respective model checkpoints. In an embodiment, the circuitry 202 may save the model files and the metadata associated with each of the speech recognition model 102A, the voice conversion model 102B, and the TTS conversion model 102C on a persistent storage.

At 434, next iteration (i+1) may be selected for the execution of the set of operations. In an embodiment, the circuitry 202 may select the next iteration (i+1) for the execution of the set of operations. After the selection, the set of operations from 416 to 434 may be repeated until the voice conversion loss associated with the voice conversion model 102B is below a loss threshold. Additionally, or alternatively, the set of operations may be executed until a Word Error Rate (WER) associated with the speech recognition model 102A is below a threshold WER loss. Additionally, or alternatively, the set of operations may be executed until the number of the iterations until a TTS loss associated with the TTS conversion model 102C is below a threshold TTS loss.

Although the flowchart 400 is illustrated as discrete operations, such as from 404 to 434, the disclosure is not so limited. Accordingly, in certain embodiments, such discrete operations may be further divided into additional operations, combined into fewer operations, or eliminated, depending on the implementation without detracting from the essence of the disclosed embodiments.

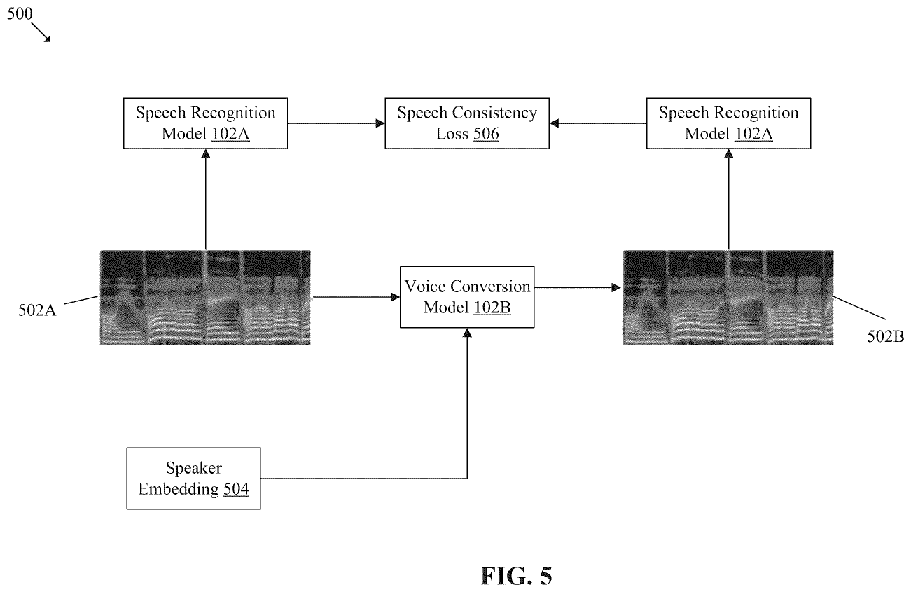

FIG. 5 is a diagram that illustrates an exemplary processing scenario for training of a voice conversion model, in accordance with an embodiment of the disclosure. FIG. 5 is described in conjunction with elements from FIG. 1, FIG. 2, FIG. 3, and FIGS. 4A and 4B. With reference to FIG. 5, there is shown an exemplary scenario 500. The exemplary scenario 500 may include an input mel-spectrogram 502A, an output mel-spectrogram 502B, a speaker embedding 504, a speech consistency loss 506, the speech recognition model 102A, and the voice conversion model 102B. A set of operations associated with the scenario 500 is described herein.

With reference to the scenario 500, the input mel-spectrogram 502A and the speaker embedding 504 may be provided as an input to the voice conversion model 102B. Based on application of the voice conversion model 102B on the input mel-spectrogram 502A and the speaker embedding 504, the output mel-spectrogram 502B may be generated. The output mel-spectrogram 502B may include linguistic content of the input mel-spectrogram 502A in a voice of a human speaker (for example, the user 114) associated with the speaker embedding 504. The input mel-spectrogram 502A and the output mel-spectrogram 502B may be provided as inputs to the speech recognition model 102A to determine the speech consistency loss 506. The speech consistency loss 506 may be determined based on the equation (1). The speech consistency loss 506 may indicate a closeness of a linguistic content of the output mel-spectrogram 502B from the linguistic content of the input mel-spectrogram 502A.

Thereafter, the voice conversion model 102B may be trained or finetuned based on the computed speech consistency loss 506. It should be noted that the scenario 500 of FIG. 5 is merely an example and such an example should not be construed as limiting the scope of disclosure.

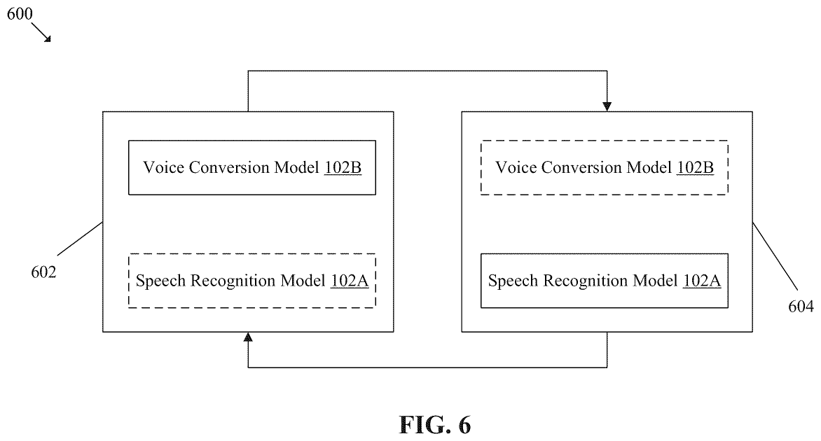

FIG. 6 is a diagram that illustrates an exemplary scenario for iterative training of a speech recognition model and a voice conversion model, in accordance with an embodiment of the disclosure. FIG. 6 is described in conjunction with elements from FIG. 1, FIG. 2, FIG. 3, FIGS. 4A and 4B, and FIG. 5. With reference to FIG. 6, there is shown an exemplary scenario 600. The exemplary scenario 600 may include a block 602, a block 604, the speech recognition model 102A, and the voice conversion model 102B. A set of operations associated with the scenario 600 is described herein.

With reference to the scenario 600, in a first step, the speech recognition model 102A may be trained based on the dataset 110. The dataset 110 may be a low resource speech dataset “τ”. The trained speech recognition model 102A may be denoted as “Ao”. Thereafter, the voice conversion model 102B may be trained in order to minimize the speech consistency loss. The trained voice conversion model 102B may be denoted as “V0”. In a next step, the trained voice conversion model 102B may be applied on the dataset 110 to generate the augmented speech dataset (for example, the augmented speech dataset of FIGS. 4A and 4B). The augmentation may artificially increase diversities of the dataset 110 in terms of speaker styles. The augmented speech dataset may be denoted as “\hat{τ}₁”.

With reference to the block 602, the trained speech recognition model 102A (denoted as “Ao”) may be finetuned based on the augmented speech dataset that may be denoted as “\hat{τ}₁”. During the fine-tuning of the speech recognition model 102A, the training parameters of the trained voice conversion model 102B may be frozen. The finetuned speech recognition model 102A may be denoted as “A1”.

With reference to the block 604, the finetuned speech recognition model 102A (denoted as “A1”) may be used to finetune the trained voice conversion model 102B. During the fine-tuning of the trained voice conversion model 102B, the training parameters of the finetuned speech recognition model 102A may be frozen. The process of iteratively fine-tuning of the speech recognition model 102A and the voice conversion model 102B may be executed until the WER of the finetuned speech recognition model 102A converges on the validation set. It should be noted that the scenario 600 of FIG. 6 is merely an example and such an example should not be construed as limiting the scope of disclosure.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include receiving a text dataset and a dataset associated with a speech recognition task. The operations may further include training a speech recognition model for the speech recognition task and a voice conversion model for a voice conversion task based on the trained speech recognition model. The operations may further include training a TTS conversion model for a text-to-speech conversion task and executing a set of operations. The set of operations may include generating an augmented speech dataset based on an application of the trained voice conversion model on the dataset; finetuning the TTS conversion model based on the augmented speech dataset; applying the finetuned TTS on the text dataset to generate speech samples corresponding to text samples in the text dataset; applying the voice conversion model on the speech samples to generate augmented text-speech dataset; finetuning the trained speech recognition model based on the augmented text-speech dataset; and finetuning the trained voice conversion model based on the received dataset and the finetuned speech recognition model. The set of operations may be executed for a number of iterations until a loss associated with the voice conversion model is below a threshold loss.

Exemplary aspects of the disclosure may provide an electronic device (such as, the electronic device 102 of FIG. 1) that includes circuitry (such as, the circuitry 202). The circuitry 202 may be configured to receive a text dataset and a dataset associated with a speech recognition task. The circuitry 202 may be further configured to train the speech recognition model 102A for the speech recognition task and the voice conversion model 102B for a voice conversion task based on the trained speech recognition model 102A. The circuitry 202 may be further configured to train the TTS conversion model 102C for a text-to-speech conversion task and execute a set of operations. Such operations may include an operation to generate an augmented speech dataset based on an application of the trained voice conversion model 102B on the dataset 110; an operation to finetune the TTS conversion model 102C based on the augmented speech dataset; an operation to apply the finetuned TTS conversion model 102C on the text dataset 112 to generate speech samples corresponding to text samples in the text dataset 112; an operation to apply the trained voice conversion model 102B on the speech samples to generate augmented text-speech dataset; an operation to finetune the trained speech recognition model 102A based on the augmented text-speech dataset; and an operation to finetune the trained voice conversion model 102B based on the received dataset and the finetuned speech recognition model 102A. The set of operations may be executed for a number of iterations until a loss associated with the voice conversion model 102B is below a threshold loss.

In accordance with an embodiment, the circuitry 202 may be further configured to determine whether the dataset 110 only includes the speech samples in the dataset 110. The circuitry 202 may generate synthetic text samples corresponding to the speech samples based on application of the trained speech recognition model 102A on the speech samples. The augmented text-speech dataset may include the synthetic text samples and the speech samples.

In accordance with an embodiment, the dataset 110 may include at least one of voice recordings of a set of human speakers in one or more languages and text transcripts corresponding to the voice recordings.

In accordance with an embodiment, the circuitry 202 may be further configured to: generate mel-spectrograms corresponding to the voice recordings; feed inputs that include the mel-spectrograms and speaker embeddings associated with the mel-spectrograms to the trained voice conversion model 102B or the finetuned voice conversion model 102B to generate mel-spectrogram predictions; and compute the speech consistency loss by use of the trained speech recognition model 102A or the finetuned speech recognition model 102A. The speech consistency loss may be computed based on the mel-spectrogram predictions and the inputs that include the mel-spectrograms. The voice conversion model 102B may be trained or finetuned based on the computed speech consistency loss.

In accordance with an embodiment, the speaker embedding may include information associated with a pitch, a loudness, an intensity of a voice of a human speaker.

In accordance with an embodiment, the circuitry may be further configured to compute the loss in terms of a word error rate (WER) based on application of the trained speech recognition model or the finetuned speech recognition model on a validation set of the dataset. Further, the circuitry 202 may compare the determined WER with a threshold WER loss. The speech recognition model 102A may be trained or finetuned based on the comparison.

In accordance with an embodiment, the circuitry 202 may be further configured to freeze training parameters of the trained voice conversion model 102B or the finetuned voice conversion model 102B while the speech recognition model 102A or the TTS conversion model 102C is finetuned over the iterations.

In accordance with an embodiment, the circuitry 202 may be further configured to freeze training parameters of the trained speech recognition model 102A or the finetuned speech recognition model 102A while the voice conversion model 102B is finetuned over the iterations.

In accordance with an embodiment, the set of operations may be further executed for the number of the iterations until a Word Error Rate (WER) loss associated with the speech recognition model 102A is below a threshold WER loss.

In accordance with an embodiment, the set of operations may be further executed for the number of the iterations until a TTS loss associated with the TTS conversion model 102C is below a threshold TTS loss.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive a dataset associated with a speech recognition task;
receive a text dataset;
train a speech recognition model for the speech recognition task;
train a voice conversion model for a voice conversion task based on the trained speech recognition model;
train a text-to-speech (TTS) model for a text-to-speech conversion task; and
execute a set of operations, which includes:
an operation to generate an augmented speech dataset based on an application of the trained voice conversion model on the dataset;
an operation to finetune the TTS conversion model based on the augmented speech dataset;
an operation to apply the finetuned TTS conversion model on the text dataset to generate speech samples corresponding to text samples in the text dataset;
an operation to apply the voice conversion model on the speech samples to generate augmented text-speech dataset;
an operation to finetune the trained speech recognition model based on the augmented text-speech dataset; and
an operation to finetune the trained voice conversion model based on the received dataset and the finetuned speech recognition model,
wherein the set of operations is executed for a number of iterations until a loss associated with the voice conversion model is below a threshold loss.

2. The electronic device according to claim 1, wherein the circuitry is further configured to:
determine whether the dataset only includes the speech samples in the dataset; and
generate the text samples corresponding to the speech samples based on application of the trained speech recognition model on the speech samples; and
wherein the augmented text-speech dataset includes the text samples and the speech samples.

3. The electronic device according to claim 1, wherein the dataset includes at least one of voice recordings of a set of human speakers in one or more languages and text transcripts corresponding to the voice recordings.

4. The electronic device according to claim 3, wherein the circuitry is further configured to:
generate mel-spectrograms corresponding to the voice recordings;
feed inputs that include the mel-spectrograms and speaker embeddings associated with the mel-spectrograms to the trained voice conversion model or the finetuned voice conversion model to generate mel-spectrogram predictions; and
compute a speech consistency loss by use of the trained speech recognition model or the finetuned speech recognition model, wherein
the speech consistency loss is computed based on the mel-spectrogram predictions and the inputs that include the mel-spectrograms, and
the voice conversion model is trained or finetuned based on the computed speech consistency loss.

5. The electronic device according to claim 4, wherein the speaker embeddings include information associated with a pitch, a loudness, an intensity of a voice of a human speaker.

6. The electronic device according to claim 1, wherein the circuitry is further configured to:
compute the loss in terms of a word error rate (WER) based on application of the trained speech recognition model or the finetuned speech recognition model on a validation set of the dataset; and
compare the determined WER with a threshold WER loss, wherein the speech recognition model is trained or finetuned based on the comparison.

7. The electronic device according to claim 1, wherein the circuitry is further configured to freeze training parameters of the trained voice conversion model or the finetuned voice conversion model while the speech recognition model or the TTS conversion model is finetuned over the iterations.

8. The electronic device according to claim 1, wherein the circuitry is further configured to freeze training parameters of the trained speech recognition model or the finetuned speech recognition model while the voice conversion model is finetuned over the iterations.

9. The electronic device according to claim 1, wherein the set of operations is further executed for the number of the iterations until a Word Error Rate (WER) loss associated with the speech recognition model is below a threshold WER loss.

10. The electronic device according to claim 1, wherein the set of operations is further executed for the number of the iterations until a TTS loss associated with the TTS conversion model is below a threshold TTS loss.

11. A method, comprising:
in an electronic device:
receiving a dataset associated with a speech recognition task;
receiving a text dataset;
training a speech recognition model for the speech recognition task;
training a voice conversion model for a voice conversion task based on the trained speech recognition model;
training a text-to-speech (TTS) model for a text-to-speech conversion task; and
executing a set of operations comprising:
generating an augmented speech dataset based on an application of the trained voice conversion model on the dataset;
finetuning the TTS conversion model based on the augmented speech dataset;
applying the finetuned TTS conversion model on the text dataset to generate speech samples corresponding to text samples in the text dataset;
applying the voice conversion model on the speech samples to generate augmented text-speech dataset;
finetuning the trained speech recognition model based on the augmented text-speech dataset; and
finetuning the trained voice conversion model based on the received dataset and the finetuned speech recognition model,
wherein the set of operations is executed for a number of iterations until a loss associated with the voice conversion model is below a threshold loss.

12. The method according to claim 11, further comprising:
determining whether the dataset only includes the speech samples in the dataset; and
generating the text samples corresponding to the speech samples based on application of the trained speech recognition model on the speech samples; and
wherein the augmented text-speech dataset includes the text samples and the speech samples.

13. The method according to claim 11, wherein the dataset includes at least one of voice recordings of a set of human speakers in one or more languages and text transcripts corresponding to the voice recordings.

14. The method according to claim 13, further comprising:
generating mel-spectrograms corresponding to the voice recordings;
feeding inputs that include the mel-spectrograms and speaker embeddings associated with the mel-spectrograms to the trained voice conversion model or the finetuned voice conversion model to generate mel-spectrogram predictions; and
computing a speech consistency loss by use of the trained speech recognition model or the finetuned speech recognition model, wherein
the speech consistency loss is computed based on the mel-spectrogram predictions and the inputs that include the mel-spectrograms, and
the voice conversion model is trained or finetuned based on the computed speech consistency loss.

15. The method according to claim 11, further comprising:
computing the loss in terms of a word error rate (WER) based on application of the trained speech recognition model or the finetuned speech recognition model on a validation set of the dataset; and
comparing the determined WER with a threshold WER loss,
wherein the speech recognition model is trained or finetuned based on the comparison.

16. The method according to claim 11, further comprising freezing training parameters of the trained voice conversion model or the finetuned voice conversion model while the speech recognition model or the TTS conversion model is finetuned over the iterations.

17. The method according to claim 11, further comprising freezing training parameters of the trained speech recognition model or the finetuned speech recognition model while the voice conversion model is finetuned over the iterations.

18. The method according to claim 11, wherein the set of operations is further executed for the number of the iterations until a Word Error Rate (WER) loss associated with the speech recognition model is below a threshold WER loss.

19. The method according to claim 11, wherein the set of operations is further executed for the number of the iterations until a TTS loss associated with the TTS conversion model is below a threshold TTS loss.

20. A non-transitory computer-readable medium having stored thereon, computer-executable instructions that when executed by an electronic device, causes the electronic device to execute operations, the operations comprising:
receiving a dataset associated with a speech recognition task;
receiving a text dataset;
training a speech recognition model for the speech recognition task;
training a voice conversion model for a voice conversion task based on the trained speech recognition model;
training a text-to-speech (TTS) model for a text-to-speech conversion task; and
executing a set of operations comprising:
generating an augmented speech dataset based on an application of the trained voice conversion model on the dataset;
finetuning the TTS conversion model based on the augmented speech dataset;
applying the finetuned TTS conversion model on the text dataset to generate speech samples corresponding to text samples in the text dataset;
applying the voice conversion model on the speech samples to generate augmented text-speech dataset;
finetuning the trained speech recognition model based on the augmented text-speech dataset; and
finetuning the trained voice conversion model based on the received dataset and the finetuned speech recognition model,
wherein the set of operations is executed for a number of iterations until a loss associated with the voice conversion model is below a threshold loss.
